(19) United States
(12) Patent Application Publication
(10) Pub. No.: US 2026/0338247 A1
(43) Pub. Date: Oct. 29, 2026

(54) HYDRAULIC DAMPER

(71) Applicant: The Dynamic Engineering Solution Pty Ltd, Holden Hill (AU)

(72) Inventors: Oscar FIORINOTTO, Holden Hill (AU); Max O'CONNELL, Holden Hill (AU)

(73) Assignee: The Dynamic Engineering Solution Pty Ltd, Holden Hill, SA (AU)

(21) Appl. No.: 18/998,992

(22) PCT Filed: Jul. 28, 2023
(86) PCT No.: PCT/AU2023/050701

§ 371 Date: Jan. 27, 2025

(30) Foreign Application Priority Data
Jul. 28, 2022 (AU) 2022902119

(51) Int. Cl. F16F 9/06; F16F 9/32; F16F 9/34; F16F 9/43; F16F 9/516

(52) U.S. Cl. CPC F16F 9/064; F16F 9/061; F16F 9/063; F16F 9/3221; F16F 9/34; F16F 9/43; F16F 9/516; F16F 9/065; F16F 2222/126; F16F 2228/066; F16F 2230/18; F16F 2230/42; F16F 2232/08; F16F 2234/02

(57) ABSTRACT

A hydraulic damper, comprising a damper cylinder having an internal volume configured to contain a fluid therein, a damper piston slidably retained within the damper cylinder and separating the internal volume of the damper cylinder into a first fluid chamber and a second fluid chamber, a piston rod for driving the damper piston within the damper cylinder in compression and extension, at least one valve arrangement configured to allow the flow of fluid between the first and second fluid chambers during compression and extension of the hydraulic damper, and a pressure source configured to provide pressure to both the first and second fluid chambers during compression and extension of the hydraulic damper.

### PRIORITY DOCUMENTS

The present application claims priority from Australian Provisional Patent Application No. 2022902119 titled “HYDRAULIC DAMPER” and filed on 28 Jul. 2022, the content of which is hereby incorporated by reference in its entirety.

### TECHNICAL FIELD

The present invention relates to a hydraulic damper.

### BACKGROUND

A hydraulic damper converts kinetic energy into heat energy using viscous friction of a non-compressible fluid (such as hydraulic oil). Typically, this is achieved by passing oil through restrictions, such as restricted apertures (also known as ports) and valve mechanisms (such as shim stacks on either side of the apertures) which generate hydraulic resistance. Damping coefficient adjustments can be made by varying the aperture size and/or varying the configuration of the valve mechanism.

A typical hydraulic damper comprises a damper cylinder, piston rod, hydraulic piston and gas reservoir. The damper cylinder is full of hydraulic oil and sealed on both ends. The hydraulic piston is attached to the piston rod, which enters the damper cylinder through rod seals. The hydraulic piston moves through the hydraulic oil when forces are applied to the piston rod. As the piston rod enters the sealed damper cylinder, the internal oil volume capacity is reduced, wherein this volume of oil is taken up by the gas reservoir which can take many different forms depending on the damper design, such as mono-tube, twin tube or remote reservoir.

A known issue that affects hydraulic dampers is cavitation, where numerous pockets of oil vapour are created throughout the oil when the hydraulic oil vapour pressure exceeds the local static pressure. This phenomenon typically occurs when the differential pressure across the restrictions is great enough that downstream pressure falls low enough to pull dissolved air out of the oil, creating the pockets of vapour. When cavitation occurs, a small increase in static pressure will easily turn the oil vapour back into liquid, producing vibration and noise, reducing the working efficiency and possibly damaging the internals of the damper.

It is against this background that the present disclosure has been developed.

### SUMMARY

According to a first aspect, there is provided a hydraulic damper, comprising a damper cylinder having an internal volume configured to contain a fluid therein, a damper piston slidably retained within the damper cylinder and separating the internal volume of the damper cylinder into a first fluid chamber and a second fluid chamber, a piston rod for driving the damper piston within the damper cylinder in compression and extension, at least one valve arrangement configured to allow a flow of fluid between the first and second fluid chambers during compression and extension of the hydraulic damper, and a pressure source configured to provide pressure to both the first and second fluid chambers during compression and extension of the hydraulic damper.

In one form, the pressure source is a hydraulic accumulator comprising a compressible gas volume.

In one form the hydraulic damper further comprises a separator piston slidably retained within an internal volume of the piston rod, wherein the damper piston, the piston rod and the separator piston collectively define the first and second fluid chambers, a third fluid chamber, and a fourth fluid chamber, wherein the first fluid chamber is defined by at least an inner surface of the damper cylinder and a first surface of the damper piston, the second fluid chamber is defined by an annulus formed between at least the inner surface of the damper cylinder, an outer surface of the piston rod and a second surface of the damper piston, the third fluid chamber is defined by at least an inner surface of the piston rod, a third surface of the damper piston and a first surface of the separator piston, and the fourth fluid chamber is defined by at least the inner surface of the piston rod and a second surface of the separator piston, and wherein the first, second and third fluid chambers are configured to contain a non-compressible liquid and the fourth fluid chamber is configured to contain a compressible gas.

In one form, the damper piston comprises the at least one valve arrangement.

In one form, at least one valve arrangement comprises a compression valve arrangement for allowing the flow of fluid from the first fluid chamber to the second fluid chamber during compression of the hydraulic damper.

In one form, the compression valve arrangement comprises a compression flow control element, configured to provide a compression damping force as fluid flows from the first fluid chamber to the second fluid chamber.

In one form, the at least one valve arrangement comprises an extension valve arrangement for allowing the flow of fluid from the second fluid chamber to the first fluid chamber during extension of the hydraulic damper.

In one form, the extension valve arrangement comprises an expansion flow control element, configured to provide an expansion damping force as fluid flows from the second fluid chamber to the first fluid chamber.

In one form, the hydraulic damper further comprises at least one adjustable flow control element, configured to provide an adjustable damping force as fluid flows between the first and second fluid chambers via a bypass flow path external to the damper cylinder.

In one form, the at least one adjustable flow control element comprises an adjustable compression flow control element configured to provide an adjustable compression damping force as fluid flows from the first fluid chamber to the second fluid chamber via the bypass flow path.

In one form, the at least one adjustable flow control element comprises an adjustable expansion flow control element configured to provide an adjustable expansion damping force as fluid flows from the second fluid chamber to the first fluid chamber via the bypass flow path.

### BRIEF DESCRIPTION OF DRAWINGS

Embodiments of the present invention will be discussed with reference to the accompanying drawings wherein:

FIG. 1 is a schematic of a hydraulic damper, according to an embodiment;

FIG. 2 is a schematic of a hydraulic damper, according to an alternate embodiment;

FIG. 3 is a perspective view of a hydraulic damper, according to an embodiment;

FIG. 4 is a sectional view of the hydraulic damper of FIG. 3;

FIG. 5 is a sectional view of the damper piston from the hydraulic damper of FIG. 3, illustrating the internal features of the damper piston facilitating the flow of fluid through the piston during compression; and

FIG. 6 is an alternate sectional view of the damper piston from the hydraulic damper of FIG. 3, illustrating the internal features of the damper piston facilitating the flow of fluid through the piston during extension.

### DESCRIPTION OF EMBODIMENTS

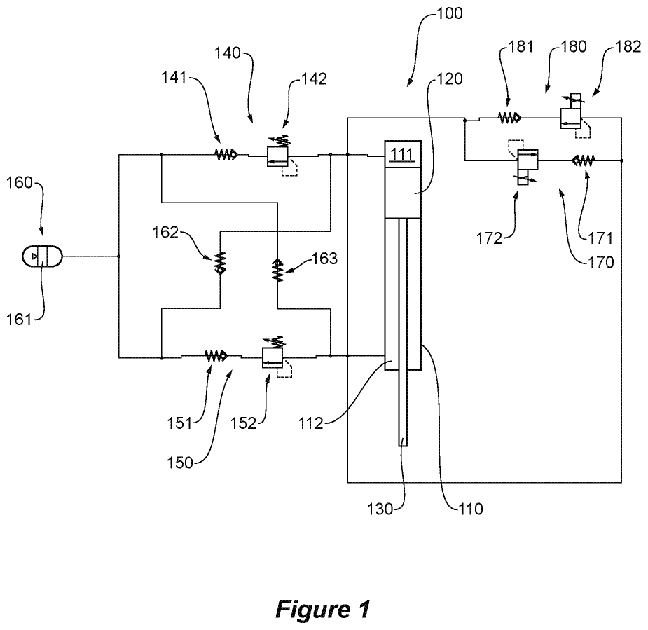

Referring to FIG. 1, there is shown a schematic of a hydraulic damper 100, according to an embodiment. The hydraulic damper 100 comprises a damper cylinder 110 having an internal volume configured to contain a fluid (such as hydraulic oil) therein. The hydraulic damper 100 also comprises a piston 120 slidably retained within the damper cylinder 110 and configured to separate the internal volume of the damper cylinder into a first fluid chamber 111 and a second fluid chamber 112, as well as a piston rod 130 for driving the piston 120 within the damper cylinder 110 in compression and extension (also known as bump and rebound). As used herein, the term “extension” may be used interchangeably with “expansion”. The hydraulic damper 100 further comprises a compression valve arrangement 140 for allowing the flow of fluid from the first fluid chamber 111 to the second fluid chamber 112 during compression of the hydraulic damper 100, and an extension valve arrangement 150 for allowing the flow of fluid from the second fluid chamber 112 to the first fluid chamber 111 during extension of the hydraulic damper 100. The hydraulic damper 100 also comprises a pressure source 160 configured to provide pressure to both the first fluid chamber 111 and the second fluid chamber 112.

It can be seen that the pressure source 160 is in the form of a hydraulic accumulator 161 fluidly connected to both the first and second fluid chambers 111, 112 via first and second check valves 162, 163. It will be appreciated that pressurised fluid can only flow directly from the accumulator 161 to the first and second fluid chambers 111, 112 and not the other way around. When the damper 100 is at rest, it will be appreciated that respective pressures in the first and second fluid chambers 111, 112 will be equal to the gas pressure in the accumulator 161.

When the damper 100 undergoes compression, it will be appreciated that the volume of the first fluid chamber 111 decreases and the volume of the second fluid chamber 112 increases, resulting in fluid from the first fluid chamber 111 flowing through the compression valve arrangement 140 to the second fluid chamber 112. It will also be appreciated that the gas volume in the accumulator 161 will compress in order to accommodate fluid displaced from the damper cylinder 110 by the piston rod 130 being driven into the damper cylinder 110.

It will be appreciated that compression will cause a pressure drop across the damper piston 120, and if the pressure drop caused by the compressive force is sufficient, pressure in the second fluid chamber 112 may become low enough that cavitation will occur. However, it will be appreciated that by virtue of the accumulator 161 being in fluid communication with the second fluid chamber 112, gas pressure from the accumulator 161 is able to be maintained in the second fluid chamber 112, reducing the likelihood of cavitation occurring.

When the damper 100 undergoes extension, it will be appreciated that the volume of the second fluid chamber 112 decreases and the volume of the first fluid chamber 111 increases, resulting in fluid from the second fluid chamber 112 flowing through the expansion valve arrangement 150 to the first fluid chamber 111. It will also be appreciated that the gas volume in the accumulator 161 will expand as fluid is restored to the damper cylinder 110 by the piston rod 130 withdrawing from the damper cylinder 110.

It will be appreciated that expansion will also cause a pressure drop across the damper piston 120, and if the pressure drop caused by the expansive force is sufficient, pressure in the first fluid chamber 111 may become low enough that cavitation will occur. However, it will again be appreciated that by virtue of the accumulator 161 being in fluid communication with the first fluid chamber 111, gas pressure from the accumulator 161 is able to be maintained in the first fluid chamber 111, reducing the likelihood of cavitation occurring.

It can be seen that both the compression and expansion valve arrangements 140, 150 are represented schematically as check valves 141, 151 and damping valves 142, 152 allowing not only for the respective one way flow of fluid between the first and second fluid chambers 111, 112 to occur, but also providing means for damping the flow of fluid at different rates. For instance, the damper valves 142, 152 may be configured such that damping of the fluid during extension is greater than the damping of the fluid during compression. While in the embodiment shown, the compression and expansion valve arrangements are in the form of check valves and damping valves, it will be appreciated that this achieves a one way flow, and that alternate damping valve arrangements also providing a one way flow are also intended to fall within the scope of this disclosure.

In addition to the compression and expansion valve arrangements 140, 150 provided, the hydraulic damper 100 may also feature second compression and extension valve arrangements 170, 180, each featuring check valves 171, 181 and adjustable damping valves 172, 182, wherein the adjustable damping valves 172, 182 are each configured to be adjustable between closed and open positions respectively.

It will be appreciated that depending on the extent to which the adjustable damping valves are opened, fluid will either flow between the fluid chambers through the first valve arrangements 140, 150 or the second valve arrangements 170, 180. Maximum damping will be achieved when the adjustable damping valves 172, 182 are closed and fluid flows through the first valve arrangements 140, 150, and minimum damping will be achieved when the adjustable damping valves 172, 182 are completely opened and fluid flows through the second valve arrangements 170, 180.

It will be appreciated that no matter how fluid is damped, the accumulator 161 remains capable of providing anti-cavitating pressure to either the first or second fluid chamber as required.

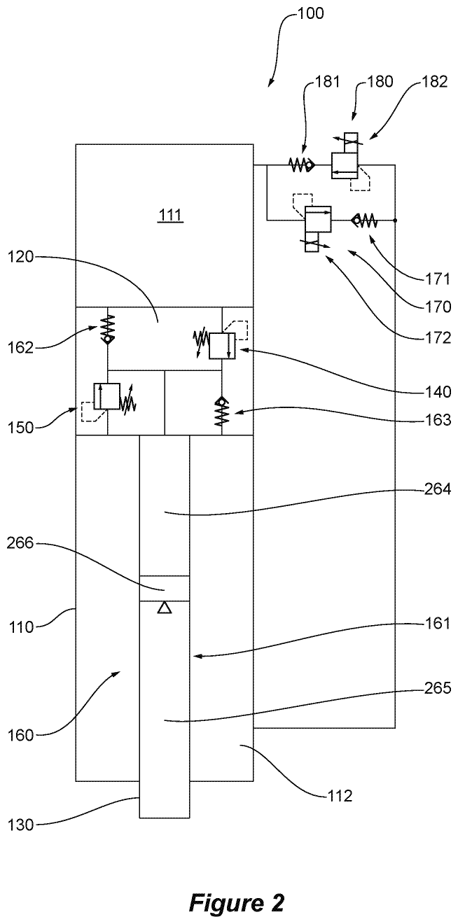

Referring now to FIG. 2, where an alternate schematic of a hydraulic damper 100 is shown. It will be appreciated that this alternate schematic operates in the same fashion as that described above, however in this embodiment the compression and extension valve arrangements 140, 150 and check valves 162, 163 are packaged within the damper piston 120, and the hydraulic accumulator 161 is packaged within the piston rod 130.

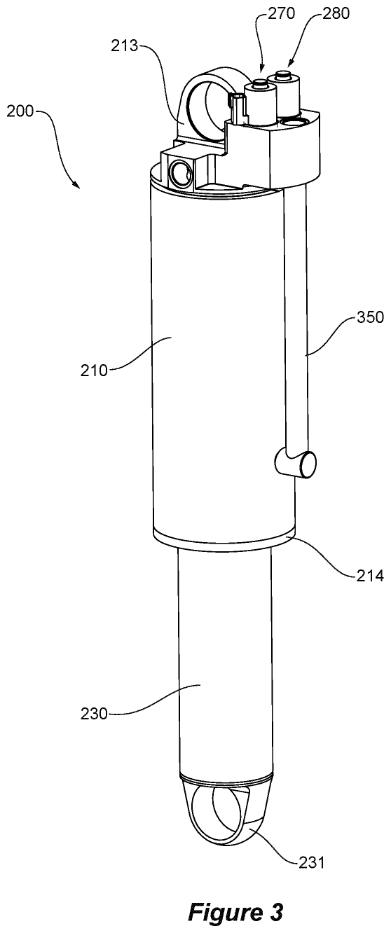

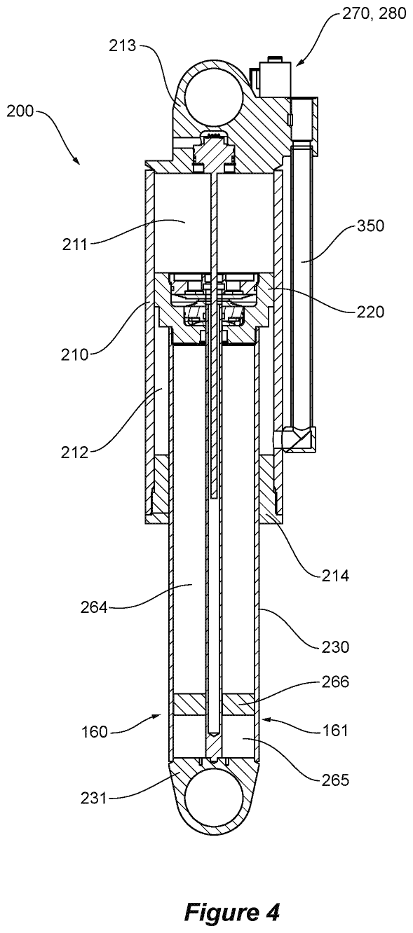

Referring now to FIGS. 3 and 4, where there is shown a sectional view of a hydraulic damper embodying the schematic shown in FIG. 2.

It can be seen that the hydraulic damper 200 comprises a damper cylinder 210 having an internal volume configured to contain a liquid therein, the damper cylinder comprising a first end closed by an upper mount 213 and a second end closed by a seal 214.

The damper 200 further comprises a damper piston 220 and a piston rod 230 slidingly retained within the damper cylinder 210, and a separator piston 266 slidably retained within an internal volume of the piston rod 230. The piston rod 230 comprises a first end to which the damper piston 220 is secured and a second end closed by a lower mount 231.

The damper piston 220, piston rod 230 and separator piston 266 collectively define first, second, third and fourth fluid chambers 211, 212, 264, 265. The first fluid chamber 211 (equivalent to the first fluid chamber of FIGS. 1 and 2) is defined by at least an inner surface of the damper cylinder 210 and a first surface of the damper piston 220. The second fluid chamber 212 (equivalent to the second fluid chamber of FIGS. 1 and 2) is defined by an annulus formed between at least an inner surface of the damper cylinder 210, an outer surface of the piston rod 230 and a second surface of the damper piston 220. The third fluid chamber 264 is defined by at least an inner surface of the piston rod 230, a third surface of the damper piston 220 and a first surface of the separator piston 266. The fourth fluid chamber 265 is defined by at least an inner surface of the piston rod 230, and a second surface of the separator piston 266.

The first, second and third fluid chambers 211, 212, 264 are configured to contain a non-compressible liquid such as a hydraulic oil. The fourth fluid chamber 265 is configured to contain a compressible gas, such as nitrogen or air, where it will become apparent that the third and fourth fluid chambers 264, 265 separated by the separator piston 266, are equivalent to the accumulator as described in relation to FIG. 1.

The damper piston 220 separates the first, second and third fluid chambers 211, 212, 264 and is configured to not only allow the flow of fluid between the first and second fluid chambers 211, 212 during compression and extension, but also facilitates fluid communication between the third fluid chamber 264 and the first and second fluid chambers 211, 212 as further described below.

During compression, the damper piston 220 is configured to allow fluid to flow from the first fluid chamber 211 to the second fluid chamber 212 via a compression valve arrangement 140. The damper piston 220 is also configured to allow fluid to flow from the first fluid chamber 211 to the third fluid chamber 264, causing the gas volume in the fourth fluid chamber 265 to compress in order to accommodate fluid displaced from the damper cylinder 210 by the piston rod 230 being driven into the damper cylinder 210. The damper piston 220 is also configured to allow fluid to flow from the third fluid chamber 264 to the second fluid chamber 212, where gas pressure from the fourth fluid chamber 265 acts on the separator piston 266 to maintain the same pressure in the second fluid chamber 212, reducing the likelihood of cavitation occurring in the second fluid chamber 212 during compression.

During extension, the damper piston 220 is configured to allow fluid to flow from the second fluid chamber 212 to the first fluid chamber 211 via an extension valve arrangement 150. The damper piston 220 is also configured to allow fluid to flow from the third fluid chamber 264 to the first fluid chamber 211, causing the gas volume in the fourth fluid chamber 265 to expand in order to accommodate fluid returned to the damper cylinder 210 by the piston rod 230 being driven out of the damper cylinder 210. It will be appreciated that the flow of fluid from the third fluid chamber 264 to the first fluid chamber 211 also allows for the gas pressure from the fourth fluid chamber 265 to act on the separator piston 266 to maintain the same pressure in the first fluid chamber 211, reducing the likelihood of cavitation occurring in the first fluid chamber during extension.

In order to achieve these various fluid communications, the damper piston 220 comprises a number of different fluid passages and valves as will be described in further detail below. It will of course be appreciated that the embodiment shown and described is just one version of how this can be achieved. It will however be appreciated that other variations would be expected to fall within the scope of this disclosure.

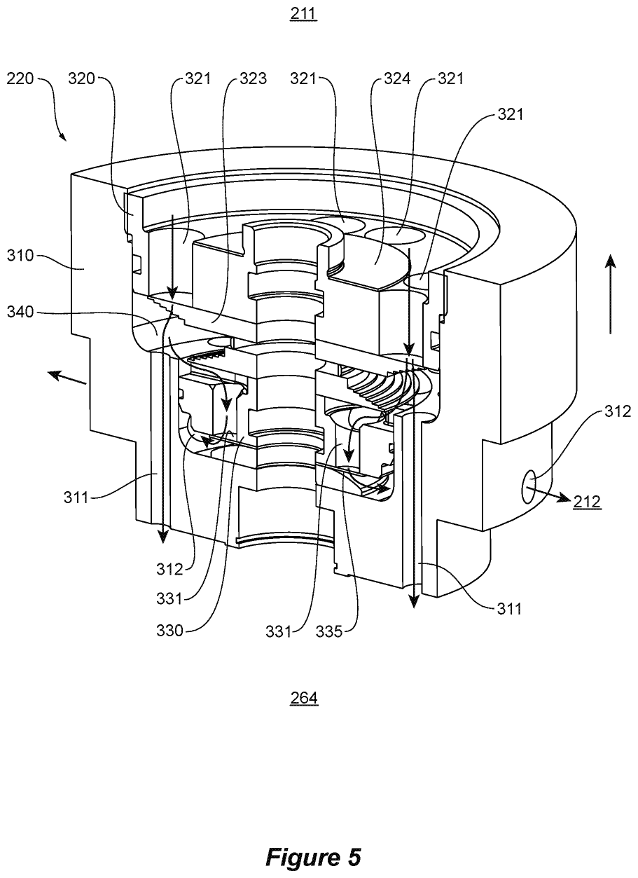

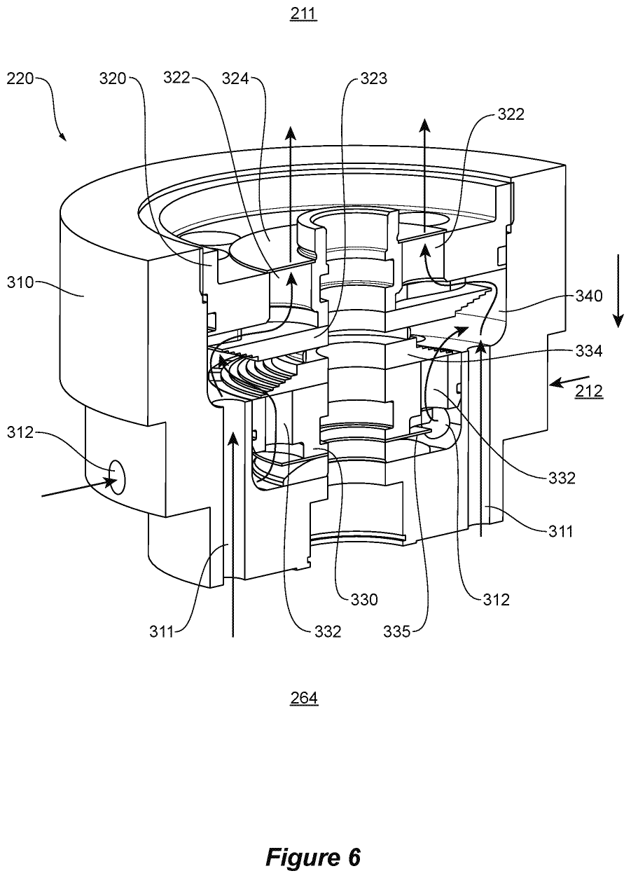

With reference to FIGS. 5 and 6, it can be seen that the damper piston 220 features a main housing 310 configured to separate the first, second and third fluid chambers 211, 212, 264. The main housing 310 is configured to receive an upper body 320 and a lower body 330 spaced apart from one another and defining an inner chamber 340. The upper body 320 is configured to control the flow of fluid to and from the first fluid chamber 211 and the lower body 330 is configured to control the flow of fluid to and from the second fluid chamber 212.

The upper body 320 comprises a plurality of compression and expansion passages 321, 322 configured to enable fluid communication between the inner chamber 340 and the first fluid chamber 211. The compression passages 321 are configured to interact with a compression valve 323, such that fluid is allowed to flow from the first fluid chamber 211 to the inner chamber 340 and is damped by the compression valve 323. The expansion passages 322 are configured to interact with an upper check valve 324, such that fluid is allowed to flow from the inner chamber 340 to the first fluid chamber 211 with minimal damping.

In the embodiment shown, the compression and expansion passages 321, 322 are arranged as two concentric rings, with the outer ring comprising the compression passages 321 and the inner ring comprising the expansion passages 322. It can be seen that the compression valve 323 is in the form of a shim stack positioned between the compression passages 321 and the inner chamber 340 on a lower surface of the upper body 320. It can be seen that the upper check valve 324 is in the form of a shim positioned between the expansion passages 322 and the first fluid chamber 211 on an upper surface of the upper body 320.

Similarly to the upper body 320, the lower body 330 comprises a plurality of compression and expansion passages 331, 332 configured to enable fluid communication between the inner chamber 340 and the second fluid chamber 212. The compression passages 331 are configured to interact with a lower check valve 335, such that fluid is allowed to flow from the inner chamber 340 to the second fluid chamber 212 with minimal damping. The expansion passages 332 are configured to interact with an expansion valve 334, such that fluid is allowed to flow from the second fluid chamber 212 to the inner chamber 340 and is damped by the expansion valve 334.

In the embodiment shown, the compression and expansion passages 331, 332 are arranged in two concentric rings, with the outer ring comprising the expansion passages 332 and the inner ring comprising the compression passages 331. It can be seen that the lower check valve 335 is in the form of a shim positioned between the compression passages 331 and the second fluid chamber 212 on a lower surface of the lower body 330. It can be seen that the expansion valve 334 is in the form of a shim stack positioned between the expansion passages 332 and the inner chamber 340 on an upper surface of the lower body 330.

It can further be seen that the main housing 310 comprises a plurality of horizontal passages 312 configured to allow fluid communication between the second fluid chamber 212 and the inner chamber 340 via either of the compression and expansion passages 331, 332 of the lower body 330. The main housing 310 also comprises a plurality of vertical passages 311 configured to allow fluid communication between the third fluid chamber 264 and the inner chamber 340.

In the embodiment shown, the damper piston 220 is assembled by stacking the lower and upper bodies 320, 330 with their associated check valves 324, 335, and shim stacks 323, 334 within the main housing 310. An outer surface of the upper body 320 comprises a threaded portion configured to threadingly engage with an inner threaded portion in the main housing 310, enabling the stack to be secured within the main housing 310.

With reference to FIG. 5 where the damper piston 220 is shown moving in compression, it can be seen that fluid flows from the first fluid chamber 211 through the plurality of compression passages 321 formed in the upper body 320 of the damper piston 220, where the fluid then passes through the compression shim stack 323 and into the inner chamber 340. The fluid then flows through to the second fluid chamber 212 via the plurality of compression passages 331 formed in the lower body 330, where the fluid passes through the lower check valve 335 before passing through the plurality of horizontal passages 312 formed in the main housing 310. Fluid is also able to flow from the inner chamber 340 to the third fluid chamber 264 through the plurality of vertical passages 311 formed in the main housing 310.

With reference to FIG. 6 where the damper piston 220 is shown moving in expansion, it can be seen that fluid flows from the second fluid chamber 212 through the plurality of horizontal passages 312 formed in the main housing 310, through the expansion passages 332 formed in the lower body 330 and then passes through the expansion shim stack 334 and into the inner chamber 340. Fluid is also able to flow from the third fluid chamber 264 to the inner chamber 340 through the plurality of vertical passages 311 formed in the main housing 310. The fluid then flows to the first fluid chamber 211 via the plurality of expansion passages 322 formed in the upper body 320, where the fluid passes through the upper check valve 324 and into the first fluid chamber 211.

It will be appreciated that by virtue of the third fluid chamber 264 being in fluid communication with the inner chamber 340, and the inner chamber 340 being in fluid communication with both the first and second fluid chambers 211, 212 via respective upper and lower check valves 324, 335, that the gas pressure from the fourth fluid chamber 265 is able to act on the separator piston 266 and provide anti-cavitating pressure to the first and second fluid chambers 211, 212 as conditions dictate.

With reference again to FIGS. 3 and 4, it can be seen that the damper 200 also comprises an external bypass tube 350 configured to connect the first and second fluid chambers 211, 212. The external bypass tube 350 is also provided with electronically adjustable compression and extension valve arrangements 270, 280, each configured to be adjustable between closed and open positions respectively. As per the discussion above, it will again be appreciated that depending on the extent to which the adjustable damping valves are opened, fluid will either flow between the first and second fluid chambers 211, 212 through damping piston 220 or via the bypass tube 350. Maximum damping will be achieved when the adjustable damping valves 270, 280 are closed and fluid flows through the damping piston 220. Minimum damping will be achieved when the adjustable damping valves 270, 280 are completely opened and fluid flows through the bypass tube 350.

It can be seen that the upper and lower mounts 213, 231 comprise upper and lower eyelets via which the damper is configured to connect to the sprung and unsprung mass of a vehicle. It will however be appreciated that alternative mounting arrangements may be employed.

It will be appreciated that the shape, size and positioning of the various passages and associated damping valves and check valves can all be varied in order to meet the operational requirements of the damper, without departing from the scope of this disclosure.

It will be appreciated that by incorporating the accumulator and associated valving within the damper piston and piston rod, that the damper is configured to provide cavitation reducing gas pressure to both the first and second fluid chambers from a single internally located pressure source.

In the embodiments shown and described, the pressure source is in the form of an accumulator with a compressible gas volume, where it will be appreciated that the pressure of the gas may be varied by pre-charging the gas via a charging port (not shown). In an alternate embodiment, the pressure of the gas may be actively controlled through connection to an additional pressure source such as a second accumulator and/or pneumatic compressor. In yet a further alternate embodiment, it will be appreciated that the gas volume may instead be replaced by a spring, or alternative mechanisms capable of providing a restorative force on the separator piston.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

The reference to any prior art in this specification is not, and should not be taken as, an acknowledgement of any form of suggestion that such prior art forms part of the common general knowledge.

In some cases, a single embodiment may, for succinctness and/or to assist in understanding the scope of the disclosure, combine multiple features. It is to be understood that in such a case, these multiple features may be provided separately (in separate embodiments), or in any other suitable combination. Alternatively, where separate features are described in separate embodiments, these separate features may be combined into a single embodiment unless otherwise stated or implied. This also applies to the claims which can be recombined in any combination. That is a claim may be amended to include a feature defined in any other claim. Further a phrase referring to “at least one of” a list of items refers to any combination of those items, including single members. As an example, “at least one of: a, b, or c” is intended to cover: a, b, c, a-b, a-c, b-c, and a-b-c.

It will be appreciated by those skilled in the art that the invention is not restricted in its use to the particular application described. Neither is the present invention restricted in its preferred embodiment with regard to the particular elements and/or features described or depicted herein. It will be appreciated that the invention is not limited to the embodiment or embodiments disclosed, but is capable of numerous rearrangements, modifications and substitutions without departing from the scope of the invention as set forth and defined by the following claims.

1. A hydraulic damper, comprising:
a damper cylinder having an internal volume configured to contain a fluid therein;
a damper piston slidably retained within the damper cylinder and separating the internal volume of the damper cylinder into a first fluid chamber and a second fluid chamber;
a piston rod for driving the damper piston within the damper cylinder in compression and extension;
at least one valve arrangement configured to allow a flow of fluid between the first and second fluid chambers during compression and extension of the hydraulic damper; and
a pressure source configured to provide pressure to both the first and second fluid chambers during compression and extension of the hydraulic damper.

2. The hydraulic damper as claimed in claim 1, wherein the pressure source is a hydraulic accumulator comprising a compressible gas volume.

3. The hydraulic damper as claimed in claim 1, further comprising a separator piston slidably retained within an internal volume of the piston rod, wherein the damper piston, the piston rod and the separator piston collectively define the first and second fluid chambers, a third fluid chamber. and a fourth fluid chamber wherein the first fluid chamber is defined by at least an inner surface of the damper cylinder and a first surface of the damper piston, the second fluid chamber is defined by an annulus formed between at least the inner surface of the damper cylinder, an outer surface of the piston rod and a second surface of the damper piston, the third fluid chamber is defined by at least an inner surface of the piston rod, a third surface of the damper piston and a first surface of the separator piston, and the fourth fluid chamber is defined by at least the inner surface of the piston rod and a second surface of the separator piston, and wherein the first, second and third fluid chambers are configured to contain a non-compressible liquid and the fourth fluid chamber is configured to contain a compressible gas.

4. The hydraulic damper as claimed in claim 1, wherein the damper piston comprises the at least one valve arrangement.

5. The hydraulic damper as claimed in claim 1, wherein the at least one valve arrangement comprises a compression valve arrangement for allowing the flow of fluid from the first fluid chamber to the second fluid chamber during compression of the hydraulic damper.

6. The hydraulic damper as claimed in claim 5, wherein the compression valve arrangement comprises a compression flow control element configured to provide a compression damping force as fluid flows from the first fluid chamber to the second fluid chamber.

7. The hydraulic damper as claimed in claim 1, wherein the at least one valve arrangement comprises an extension valve arrangement for allowing the flow of fluid from the second fluid chamber to the first fluid chamber during extension of the hydraulic damper.

8. The hydraulic damper as claimed in claim 7, wherein the extension valve arrangement comprises an expansion flow control element, configured to provide an expansion damping force as fluid flows from the second fluid chamber to the first fluid chamber.

9. The hydraulic damper as claimed claim 1, further comprising at least one adjustable flow control element, configured to provide an adjustable damping force as fluid flows between the first and second fluid chambers via a bypass flow path external to the damper cylinder.

10. The hydraulic damper as claimed in claim 9, wherein the at least one adjustable flow control element comprises an adjustable compression flow control element configured to provide an adjustable compression damping force as fluid flows from the first fluid chamber to the second fluid chamber via the bypass flow path.

11. The hydraulic damper as claimed in claim 9, wherein the at least one adjustable flow control element comprises an adjustable expansion flow control element configured to provide an adjustable expansion damping force as fluid flows from the second fluid chamber to the first fluid chamber via the bypass flow path.
